(19) United States
(12) Patent Application Publication
(10) Pub. No.: US 2003/0117428 A1
(43) Pub. Date: Jun. 26, 2003

(54) Visual summary of audio-visual program features

(75) Inventors: Dongge Li, Ossining, NY (US); John D. Zimmerman, Ossining, NY (US); Nevenka Dimitrova, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/024,778

(22) Filed: Dec. 20, 2001

(51) Int. Cl. G09G 5/00

(52) U.S. Cl. 345/716

(57) ABSTRACT

A visualization system captures and analyzes a video signal to extract features in the video signal to render a graphical multi-dimensional visual representation of the program. The visualization system includes a memory and a processor and is programmed to extract features, augment the feature extraction with supplemental information, and render a visual summary to be displayed on a display device. Using the visual summary, a user can more easily determine the nature of a particular video program.

### FIELD OF THE INVENTION

The present invention relates to a visualization system and method and, in particular, to a system and method for providing a graphic representation of particular features of a video or audio program.

### BACKGROUND OF INVENTION

Presently, some 500-plus channels of video content are available through various cable and satellite televisions systems. In addition, the Internet provides hundreds of channels of streaming video and audio content. While it would seem that one would always have access to desirable content, content seekers are often unable to sift through the endless supply of content to find the type of content they are seeking. Thus, a major complaint among television watchers is that despite hundreds of available channels, they can never find what they're looking for. This can lead to a frustrating experience and diminish one's use of the television, internet, and radio medias.

Part of the problem lies in currently available electronic program guides, which attempt to help viewers find interesting programs. In general, these systems provide only limited and subjective information regarding the program. Moreover, there is no effective way to search for particular programs based upon various features, or the relationship of multiple features.

For example, in one such system, the viewer selects a pre-designated “guide channel” and watches a cascading listing of programs that are airing (or that will be airing) within a given time interval (typically 2-3 hours). The program listing simply scrolls in order channel-by-channel, giving the viewer has no control over the program information. In fact, a viewer often has to sit through hundreds of channels before finding a desired program.

In another system, viewers access an electronic viewing guide on their television screens. The viewing guide is an electronic version of a print guide and provides information about the selected program, including the title, stars, brief description, and rating (i.e., G, PG, or R). These viewing guides fail to provide anything more that mere summary information about the program.

In yet another system, a three-dimensional electronic program guide-browsing tool was developed in which 500 TV channels could be browsed using meta-data information. These systems, however, focus on finding a specific program to watch, rather than understanding the specific content within a program. Rather than being capable of displaying information related to various features of the programs, such systems display only information related to the program as a whole.

Thus, these systems are of limited use to a viewer seeking to find particular types of content within various programs. Accordingly, there is a need for a system that visually represents the types of content contained in a particular program to allow viewers to efficiently browse various programs looking for the particular content they are seeking.

### SUMMARY OF THE INVENTION

In general, a content visualization system for rendering a visual summary of content received from a first content source comprises a memory for receiving and storing data of the content and a processor for processing instruction modules to extract various features from a program, such as a television or video program. The instruction modules can include a content/feature analyzer for extracting one or more features from the program, a visualization engine for rendering a visual representation of the content based on the extracted features, and a content augmenter for retrieving supplemental information related to the features of the content from a second content source. The visualization system can be connected to a display device for displaying the visual summary/representation rendered by the visualization engine of the system.

The visualization engine is capable renders the visual representation of the content based on both the extracted features, the supplemental information, and a user profile, which may be stored in the memory of the visualization system. The user profile may include information related to the preferences of the user.

In use, the visualization system preferably first receives a video source of a program from an external source, such as a satellite/cable television provider. The video source is advantageously then analyzed to identify and extract features from the video source. Based upon the frequency or magnitude of the extracted feature a level for each of the features extracted from the video source can be calculated. Using this information, a visual summary can be rendered and output to a display device for viewing.

The above and other features and advantages of the present invention will become readily apparent from the following detailed description thereof, which is to be read in connection with the accompanying drawings.

### BRIEF DESCRIPTION OF THE DRAWINGS

In the drawing figures, which are merely illustrative, and wherein like reference numerals depict like elements throughout the several views:

FIG. 1 is a schematic overview of a preferred embodiment of a content visualization system in accordance with the present invention;

FIG. 2 is a flow diagram of an exemplary process of producing and displaying a visual representation of content in accordance with the present invention;

FIG. 3 is a flow diagram of an exemplary process of feature extraction in accordance with the present invention;

FIG. 4 is an example of a visual representation of content features in accordance with the present invention;

FIG. 5 is another example of a visual representation of content features in accordance with the present invention;

FIG. 6 is yet another example of a visual representation of content features in accordance with the present invention; and

FIG. 7 is yet another example of a visual representation of content features in accordance with the present invention.

### DETAILED DESCRIPTION OF THE PREFERRED EMBODIMENTS

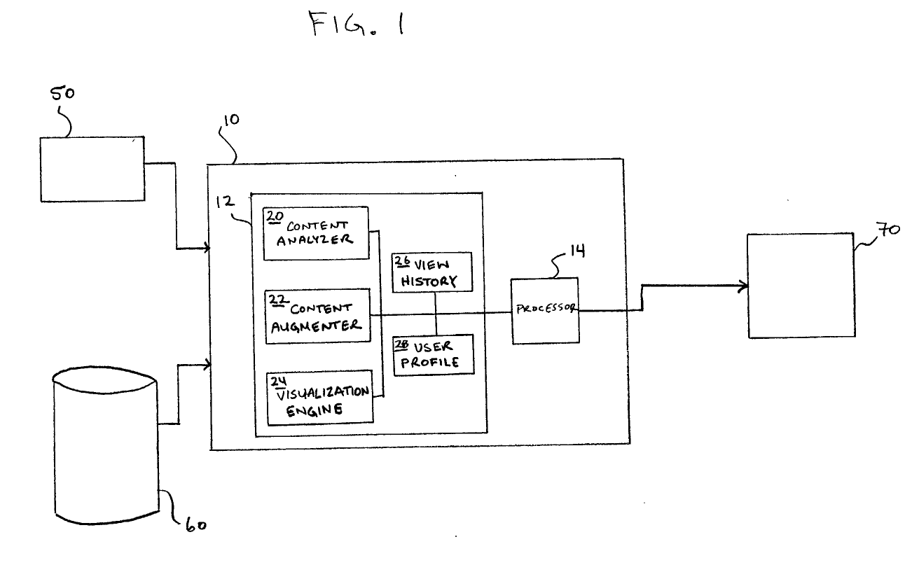

With reference to FIGS. 1-7, there is shown a feature extraction and content visualization system and method of performing content visualization. The feature extraction and content visualization system generally comprises a processing system in communication with a content source, the processing system receiving content data from the content course and extracting features from the content data. The processing system then uses the extracted features to create a visual representation of the features of the content. This visual representation is then displayed on a display device for viewing by a user of the system. As will become evident from the following detailed description, the feature extraction and content visualization system can be integrated in many different applications.

With reference to FIG. 1, there is shown an exemplary embodiment of a content visualization system 10 in accordance with the present invention. Preferably, the content visualization system 10 is interconnected to a video source 50 and an external data source 60. Video source 50 may be any source of video whether in digital or analog formats, including but not limited to cable or satellite television. External data source 60 may be source of data that is accessible via a communications network, including but not limited to the Internet or other electronically stored information database. The content visualization system 10 is also connected to a display device 70, such as a television, CRT monitor, cell phone or wireless PDA (LED) display, for displaying a visual representation or summary produced by the content visualization system 10.

The content visualization system 10 generally comprises a memory 12, which stores various data related to the user and programming for the operation of the content visualization system 10, and a processor 14, which is operative with the programming to receive, analyze video and external data, and render and output a visual summary of the video. The memory 12 may be a hard disk recorder or optical storage device, each preferably having hundreds of giga-bytes of storage capability for storing media content. One skilled in the art will recognize that any number of different memories 12 may be used to support the data storage needs of the content visualization system 10. The processor 14 may be a microprocessor and associated operating memory (RAM and ROM), and include a second processor (not shown), such as the Philips TriMedia™ Tricodec card for pre-processing the video, audio and text components of the data input. The processor 14, which may be, for example, an Intel Pentium chip or other multiprocessor, is preferably powerful enough to perform content analysis on a frame-by-frame basis, as described below.

As described above, the memory 12 stores a plurality of computer readable instructions in the form of software or firmware programs for performing the video analysis and visual summary rendering. A description of the functionality of the programming is best given in terms of three discrete program modules: a content analyzer 20, content augmenter 22, and a visualization engine 24. It should be understood, however, that the description of the programming as modules is illustrative only for the purposes of clarity. The actual format of the programming used in such an application is purely a matter of design choice.

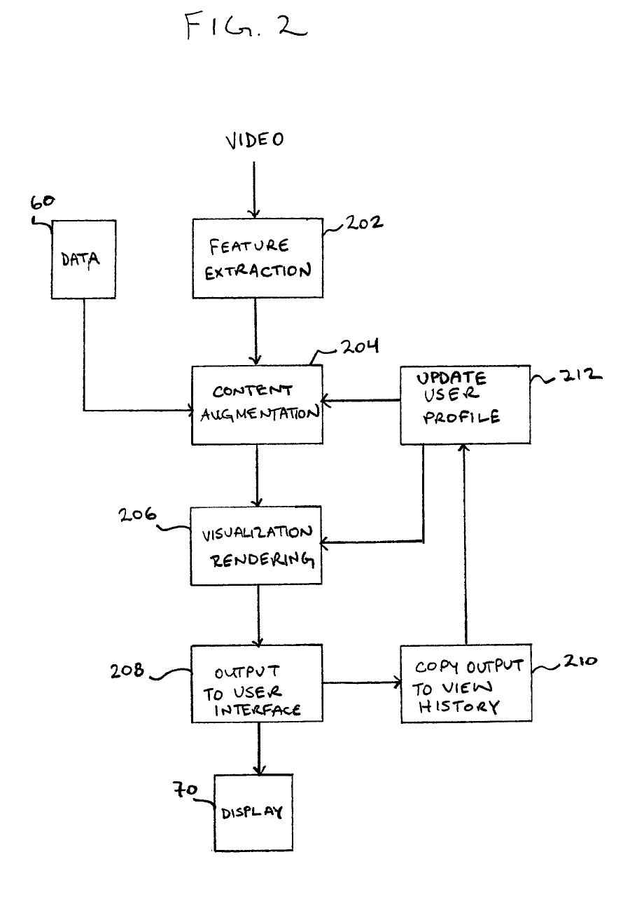

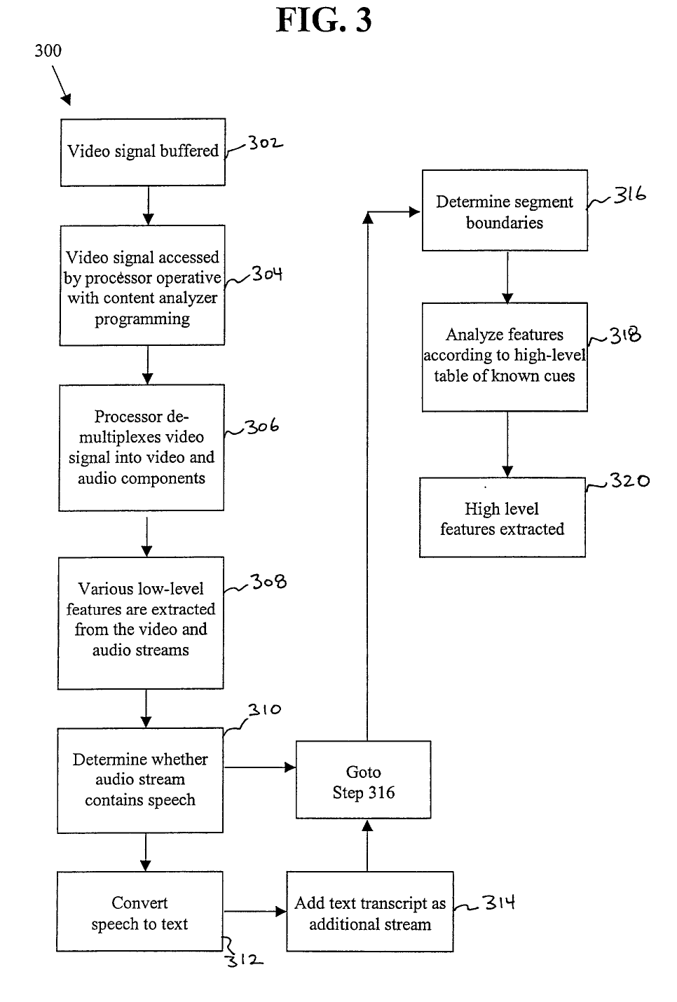

With now reference to FIGS. 1 and 2, there will be shown and described an exemplary process of creating a visual representation or summary of a video program. As described above, video enters the visualization system 10 via a network (not shown) and is temporarily stored in the memory 12 for processing by the processor 14. In step 202, as the video or audio is received by the visualization system 10, the content analyzer 20 performs feature extraction on a frame-by-frame basis. The feature extraction method, described in further detailed in connection with FIG. 3, extracts low-level features and makes high-level content inferences. Features that can be extracted for visualization include, but are not limited to dominant color, motion, audio-type, audio energy, key frames, face location, person identity, program types, and the like. As will be further described, the extracted low-level features, such as bandwidth, energy, and pitch, may be visualized by the visualization engine for viewing by a user. In step 204, the extracted features are passed to the content augmenter 22, which uses the extracted features and information from a user profile 28 that is created by the user and updated on a systematic basis, as described further below, to retrieve supplemental information related to the video content from external data sources 60.

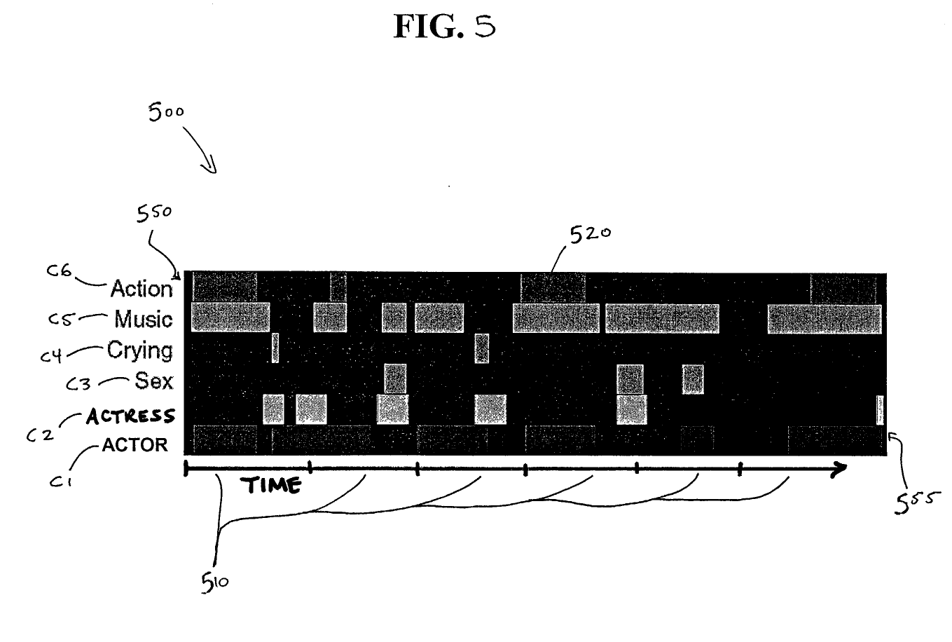

In step 206, the extracted features, along with the supplemental information, is passed to a visualization engine 24, which renders a graphical representation or summary of the video or audio content. The implementation of the visualization engine 24 depends greatly on the desired visual rendering (examples of which are depicted in FIGS. 5-7) and may be varied according to design choice. Once the video content is analyzed and features are extracted (as described below), the visualization engine translates the extracted features, such as action level, into visual components according to predefined rules and the user profile 28 and displays the results in a multi-dimensional space. For example, if action level is measured on a scale of 1-100, a rule may be set that any action level detected higher than 67 would be categorized as an action scene and visually depicted as a graphical image. In the alternative, instead of a threshold level the visualization system 10 uses various features, such as the intensity of a color in a scene, to determine the action level of a movie. In many instances, such an approach would be preferable, because many features are “fuzzy”, i.e., unable to be accurately translated into a mathematical figure, and the use of a continuous intensity monitoring gives users a more accurate feel of the features of the program. In such an example, an action scene might be graphically represented by a triangle with the color of the triangle representing the intensity of action, while a purely non-action scene might be depicted as a square. Other visual representations may be used to depict other features of the program or scene of a video. These rules may be predefined or set by the user using a graphical user interface (not shown).

In step 208, these visualization results are transmitted to a display device 70 for display in a graphical user interface (not shown). With reference again to FIGS. 1 and 2, throughout this process, a view history 26 tracks user behavior, so that it can be used to update the user profile 28. The memory 12 stores category information related to the type and nature of the video content viewed by the user in the view history 26, which is utilized in updating and keeping the user profile 28 up-to-date. In this way, the user profile 28 learns the habits and viewing preferences of the user and allows the content augmenter 22 and visualization engine 24 to be more efficient and accurate in operation. In particular, in step 210, a copy of the data of the visual summary is stored in the view history 26, which in turn is used to update the user profile 28, in step 212.

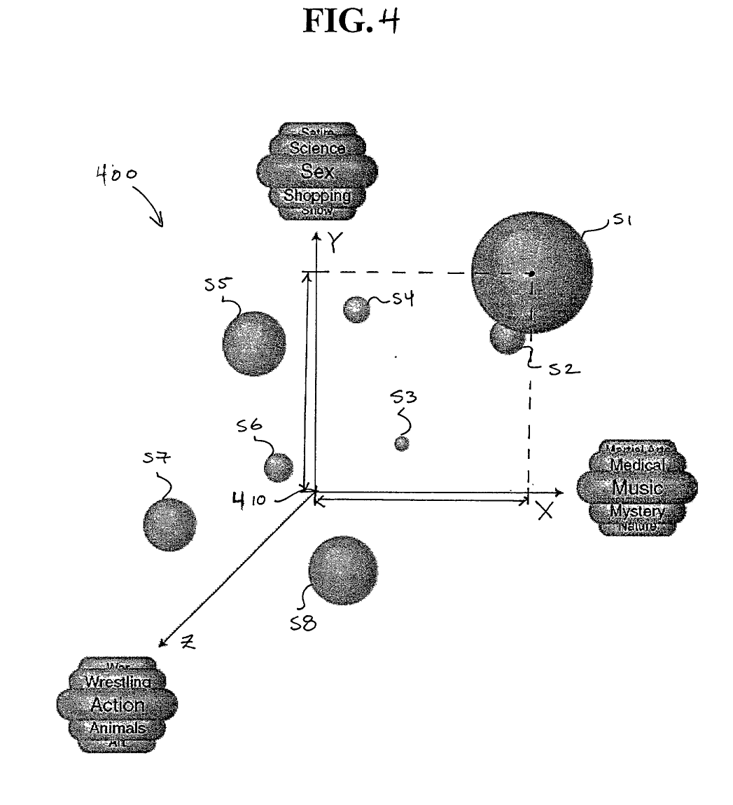

As will be described in greater detail below, the visual summary (as shown in FIGS. 4-7) can be supplemented by adding colors, shapes, textures, and other such graphical features to further expand the multidimensional display. In this way, for example, the visual summary can represent dimension well beyond three dimensions.

With reference now to FIGS. 3 and 4, there is shown a preferred method of feature extraction 300. With respect to steps 302-320, an exemplary method of performing content analysis on a video signal, such as a television NTSC signal is described. One skilled in the art will recognize that although the exemplary process describes analysis of a video signal, substantially the same process could be used to analyze an audio-only signal.

For example, each frame of the video signal may be analyzed so as to allow for the segmentation of the video data. Such methods of video segmentation include but are not limited to cut detection, face detection, text detection, motion estimation/segmentation/detection, camera motion, and the like. Furthermore, an audio component of the video signal may be analyzed. For example, audio segmentation includes but is not limited to speech to text conversion, audio effects and event detection, speaker identification, program identification, music classification, and dialogue detection based on speaker identification. Generally speaking, audio segmentation involves using low level audio features such as bandwidth, energy and pitch of the audio data input. The audio data input may then be further separated into various components, such as music and speech. Yet further, a video signal may be accompanied by transcript data (for closed captioning system), which can also be analyzed by the processor 14. As will be described further below, in operation, as the video signal is buffered, the processor 14 analyzes the signal and calculates a probability of the occurrence of a story in the video signal preferably using Bayesian software or a fusion method. By way of example only, the processor 14 analyzes the video signal to determine whether there is a high probability that a particular scene contains a particular actor/actress or action or sex content features. Each of these features when detected by the processor 14 is extracted and stored for later use in the rendering of the visual representation. It is preferred, although not necessary, that the extracted features be associated with a particular time sequence of the video signal.

With reference to FIG. 3, an exemplary process of analyzing and segmenting the video signal for story extraction is shown and described. In step 302, the processor 14 receives the video signal and temporarily buffers the signal in a memory 12 of the content visualization system 10. Next, in step 304, the processor accesses the video signal. In step 306, the processor 14 de-multiplexes the video signal to separate the signal into its video and audio components. Various features are then extracted from the video and audio streams by the processor 14, in step 308.

The processor 14 next attempts to detect whether the audio stream contains speech, in step 310. An exemplary method of detecting speech in the audio stream is described below. If speech is detected, then the processor 14 converts the speech to text to create a time-stamped transcript of the video signal, in step 312. The processor 14 then adds the text transcript as an additional stream to be analyzed, in step 314.

Whether speech is detected or not, the processor 14 then attempts to determine segment boundaries, i.e., the beginning or end of a classifiable event, in step 316. In a preferred embodiment, the processor 14 performs significant scene change detection first by extracting a new keyframe when it detects a significant difference between sequential I-frames of a group of pictures. As noted above, the frame grabbing and keyframe extracting can also be performed at pre-determined intervals. The processor 14 preferably, employs a DCT-based implementation for frame differencing using cumulative macroblock difference measure. Unicolor keyframes or frames that appear similar to previously extracted keyframes get filtered out using a one-byte frame signature. The processor 14 bases this probability on the relative amount above the threshold using the differences between the sequential I-frames.

A method of frame filtering is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For instance, when the processor begins analyzing the video signal, keyframes can be grabbed every 30 seconds.

Once these frames are grabbed every selected keyframe is analyzed. Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The audio component of the video signal may also be analyzed and monitored for the occurrence of words/sounds that are relevant to the user's request. Audio segmentation includes the following types of analysis of video programs: speech-to-text conversion, audio effects and event detection, speaker identification, program identification, music classification, and dialog detection based on speaker identification.

Audio segmentation includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation is known in the art and is generally explained in the publication by E. Wold and T. Blum entitled “Content-Based Classification, Search, and Retrieval of Audio”, IEEE Multimedia, pp. 14-36, Fall 1996, the entire disclosure of which is incorporated herein by reference.

Audio segmentation and classification includes division of the audio signal into portions of different categories (e.g. speech, music, etc.). The first step is to divide a continuous bit-stream of audio data into different non-overlapping segments such that each segment is homogenous in terms of its class. Each audio segments are then classified using low-level audio features such as bandwidth, energy and pitch. Audio segmentation and classification, as well as the relationship between low-level and mid-level features and high-level inferences, is known in the art and is generally explained in the publication by D. Li, I. K. Sethi, N. Dimitrova, and T. Mcgee, “Classification of general audio data for content-based retrieval,” Pattern Recognition Letters, pp. 533-544, Vol. 22, No. 5, April 2001, the entire disclosure of which is incorporated herein by reference. Therefore, the visualization can not only based on high-level features, but also low-level features, which, in the case of audio discussed above, can be features like energy, bandwidth.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automatic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Stories can be detected by identifying the sounds that may be associated with specific people or types of stories. For example, a lion roaring could be detected and the segment could then be characterized as a story about animals.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular celebrity or politician as set forth in the concurrently filed application entitled, “System and Method For Retrieving Information Related to Persons in Video Programs, the inventors of which are Dongge Li, Nevenka Dimitrova, and Lalitha Agnihotri.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, N.Y. Oct. 17-20, 1999.

Referring again to FIG. 3, the various components of the video, audio, and transcript text are then analyzed according to a high level table of known cues for various story types, in step 318. Each category of story preferably has knowledge tree that is an association table of keywords and categories. These cues may be set by the user in a user profile or predetermined by a manufacturer. For instance, action scenes may be characterized by fast changing scenes, loud sounds, fast music, or the presence of known action-related vehicles, such as tanks, jet fighters. Of course, the knowledge tree and related cues can be set as a matter of design choice.

After a statistical processing, in step 320, the processor 14 performs categorization using category vote histograms to extract high level features. By way of example, if a scene contains one of the features indicative of a particular type of scene, as described above, then the corresponding category gets a vote. For example, using a Bayesian approach a particular scene is categorized.

In a preferred embodiment, the various components of the segmented audio, video, and text segments are integrated to extract a story from the video signal. Integration of the segmented audio, video, and text signals is preferred for complex extraction. For example, if the user desires to retrieve a speech given by a former president, not only is face recognition required (to identify the actor) but also speaker identification (to ensure the actor on the screen is speaking), speech to text conversion (to ensure the actor speaks the appropriate words) and motion estimation-segmentation-detection (to recognize the specified movements of the actor). Thus, an integrated approach to indexing is preferred and yields more accurate results.

The above described feature analysis methods are utilized by the visualization system 10 to render visual summaries of various programs as illustrated below. With reference to FIGS. 4-7, there are shown three exemplary embodiments of a visual representation or summary of content rendered by the visualization system of the present invention. In one embodiment, shown in FIG. 4, the visualization engine produces a program map that comprises an image for each program being represented on the program map and situated in a three-dimensional space. In the example depicted in FIG. 4, each program is represented by a sphere. However, one skilled in the art will recognize that images of many different types (i.e., cones, rectangles, cubes, etc) may be used to visually represent features of the program as a matter of design choice.

Within the multi-dimensional space 400, which is represented by X, Y, and Z axes, each sphere is positioned so as to represent the particular mix of content contained within the program. The distance from the intersection of the axes, shown as reference numeral 410, represents the magnitude of a particular feature existing in the program. By way of example, if the z-axis represented the amount of action in the program, a larger sphere positioned in the hyper-dimensional space 400 would have more action than a sphere positioned to the left. As shown, the large sphere SI in the upper right hand corner of the multi-dimensional space 400 represents a program having a high magnitude in each of the three axes. In other words, a user would understand that sphere S1 represented a program that contained a substantial amount of action, music, and sexual scenes. In contrast, the small sphere S3 located close the intersection of the X, Y and Z-axes would represent a program that had very little action or sexual scenes.

Furthermore, each image in this embodiment could be colored to depict the tone of the scenes. In one example, the sphere could be colored to depict scenes having particular features. For instance, a sphere colored red could represent anger or danger, while blue could represent sorrow or coldness. Moreover, the shape of the image can be representative of certain features of the program. In effect, a fourth dimension is achieved through the geometric shape of the image and a fifth dimension is achieved by different coloring of the geometrical image.

With reference to FIG. 5, in yet another embodiment, the visualization engine 10 can create a program map 500, which summarizes the content of a video program along a timeline. In the exemplary embodiment shown, the program map is plotted horizontally to represent a timeline of the program being represented. The timeline is preferably segmented so as to break the program up into scene segments 510. Each of the scene segments 510 is frame accurate. The beginning of the program occurs at the left most portion 550 of the map 500 and the end of the program is at the right most portion 555 of the map. Along the y-axis of the map, various rows are positioned and associated with features of the program. Any number of rows C1-C6 may be devoted to any number of categories, such as action, music, crime, sex, love, and even particular actors or actresses.

In an exemplary embodiment, features in the program for a particular segment 510 are represented by shaded bars 520. For example, if a scene segment includes a particular actor, actress, and the threshold amount of action, each of the representative rows for that scene segment 510 will receive a shaded bar 520. Thus, one can quickly view the image map 500 to determine the features contained in the depicted program. In the example of FIG. 5, it can be easily recognized that the program contains music throughout the program and that that there are at least four action scenes in the program. Yet further, an image map shows that there is a high correlation between the actor (C1) and the action scenes (C6) and between the actress (C2) and the crying scenes (C4).

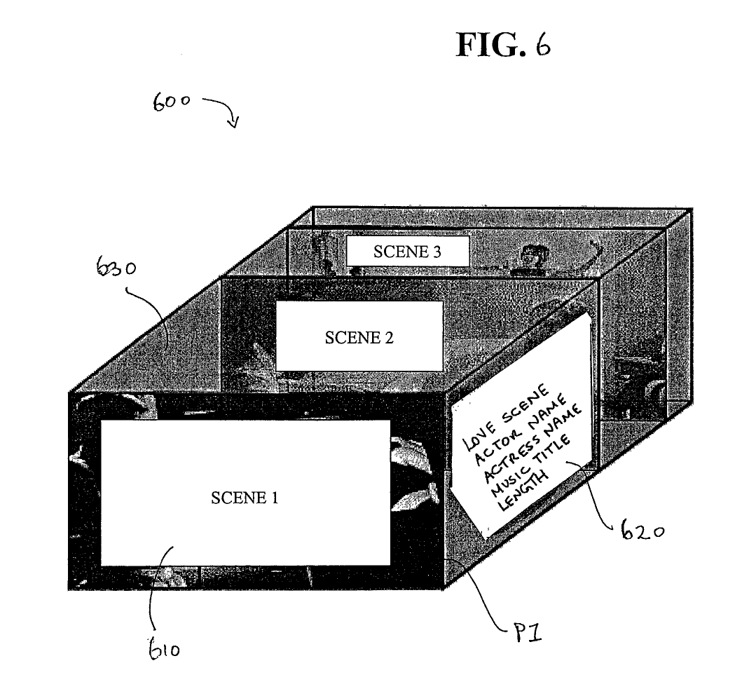

In another exemplary embodiment, as shown in FIG. 6, the visualization representation or summary may comprise a multi-dimensional geometric FIG. 600, such as a six-sided polycube, which displays a different feature of the program on the different surfaces of the geometric figure.

The multi-dimensional representation of FIG. 6 includes a program that is segmented by different features, such as the presence of an actor/actress or by a change in scene. As such, plane P1 displays a key frame 610 representing the start of a scene in the program, while the sides 620 and 630 represent features of the depicted scene. One side 620, for example, may provide information such as the type of scenes and actors/actress in the scene. In this way, a user will be able to quickly recognize a particular scene of the program that they are interested in.

It should be noted that the data visualized does not necessarily come from the original source, such as certain TV program, but rather can be the result of a query or edited result from across different programs or channels. For example, different programs with the same actor playing on different channels may be collected together and visualized. The user may then select those parts that match his/her interest based on the visualized results.

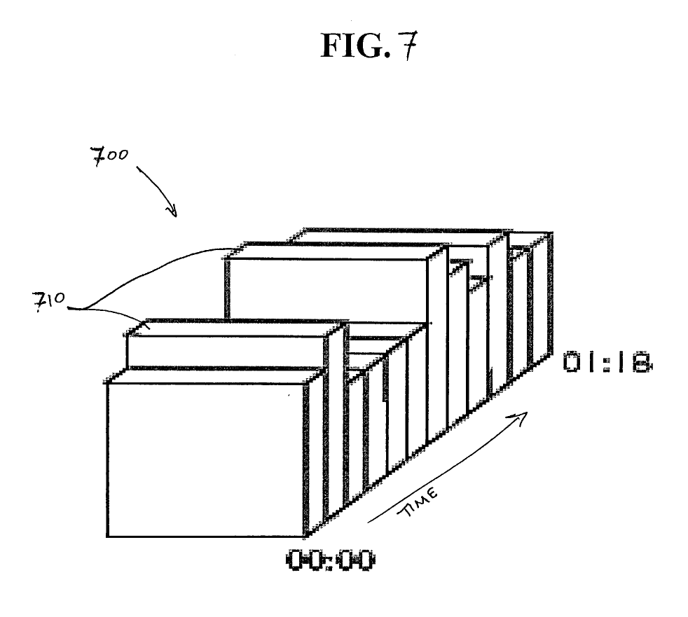

With reference to FIG. 7, there is shown yet another exemplary embodiment of a visual representation in accordance with the present invention. The visualization 700 of FIG. 7 comprises a plurality of three-dimensional bars 710. The height of each bar represents the magnitude of a particular feature that is contained within the program. Like a hyper-media document, users can select and figure certain actions on the visualization by clicking a particular bar. Each particular bar is linked to a particular scene within the program. The triggered action can include both browsing the summary data, such as sliding out from a segment of summary data and going into the next level of detail, and controlling a device such as recording the selected program or moving the recorded data to a specific personal channel. The rows in which different actions may be triggered can be predefined or stored in the user profile. In the exemplary embodiment of FIG. 7, an action movie is visualized and the taller bars represent the scenes in which the most action is present.

In sum, the visualization system is not simply a way to display text information using images, it can do much more and can be customized to better fit the nature of different types of content. The nature or feature of such multimedia content can include but is not limited to action level, sex level, romantic level, and the like. As used herein, the term “level” generally refers to the prevalence of a particular high-level inference in the content. In many cases, the level of a particular feature is “fuzzy” and is preferably continuously measured by a hyperdimension feature space. In other words, the visual representation of the level of a particular feature is multi-dimensional.

The visualization representation provides a better way of browsing multimedia content. The users in most cases, have some idea of what they like in a particular content, but need to explore somewhat to find such content. The visualization representation provides a way to see the relationship of one particular content to another in a visual summary positioned in a multi-dimensional space. In addition, the visual summary information can be provided at a macro level, e.g., an overview of what is available, and a micro level, e.g., a detailed visual summary of the content of each item or segment of the program. In this way, the user can browse the visualization results and more easily determine which program is suitable for him or her, as described below.

The visualization provides ways to browse, search, and control devices at both program and sub-program level. Also, the visualization need not be based directly on original sources. Rather, it can be derived from query or edited data as described above. In this way, the system can better integrate browse and search functionality for multimedia content, in instances where users, who do not accurately know the potential available choices, can browse and search multimedia content. By allowing such query capability being derived from previously generated visualization results. The user can pick-up a choice while browsing the visualized results and refine such choice in subsequent loops. Triggers and actions defined in user profile can be associated and/or shown with visualization results to initiate some actions to manipulate the display or a certain device (such as moving or rotation of the graph when pressing a certain button, or record the program to DVD). The visualization can be displayed either on a local device or transmitted and shown on a remote device. By way of non-limiting example, and with reference to FIG. 5, a user can view the visualization chart and notice that a particular time (scene) segment 510 the actor of choice is involved in an action scene. The user can click the bar 520 that spans the scene segment 510, which will trigger the DVD player to play that particular scene of the movie. Because the user can browse the high level features to choose scenes the present invention is advantageous over present scene selection systems commonly found on DVD's.

The visualization engine can also access the user's user profile so as to identify the viewing patterns of the user. For example, the user profile, which stores information relating to the programs viewed and related feature data, can be analyzed by the visualization engine to generate a visual summary of the viewing patterns of the user. In this way, the user can, for instance, determine how much action he/she has been watching or which actors/actresses he/she has viewed.

Similarly, the visualization engine can detect the amount of content augmentation (e.g., the amount of secondary information available for a program) contained in a program and generate a graphical representation of such content augmentation.

While the invention has been described in connection with preferred embodiments, it will be understood that modifications thereof within the principles outlined above will be evident to those skilled in the art and thus, the invention is not limited to the preferred embodiments but is intended to encompass such modifications.

We claim:

1. A content visualization system for rendering a visual summary of content received from a first content source, comprising:
a memory device for receiving and storing content from a first content source;
a content analyzer constructed to analyze the content and to identify one or more features in the content;
a visualization engine constructed to generate a signal corresponding to render a visual representation of the content characterized by the identified features; and
a display device constructed to display the visual representation.

2. The system of claim 1, further comprising a content augmenter for retrieving supplemental information related to the features of the content from a second content source and wherein the visualization engine renders a second signal corresponding to the visual representation of the content based on both the identified features and the supplemental information.

3. The system of claim 1, further comprising a stored user profile and wherein the visualization engine renders the visual representation of the content based on both the identified features and the user profile.

4. The system of claim 1, wherein the visual representation of a multi-dimensional object.

5. The system of claim 4, wherein the multi-dimensional object of the visual representation includes at least two-dimensions.

6. The system of claim 4, wherein the multi-dimensional object of the visual representation includes at least one dimension for each of the identified features.

7. The system of claim 1, wherein one of the identified features measures the prevalence of action scenes in the content.

8. The system of claim 1, wherein one of the identified features is an identity of a person.

9. The system of claim 1, wherein one of the extracted features corresponds to a prevalence of music in the content.

10. The system of claim 1, wherein the visual representation is a three-dimensional axis and wherein different identified features correspond to different axis of the content are represented by a graphical object.

11. The system of claim 10, wherein the positioning of the graphical object relates to the prevalence of the identified feature.

12. The system of claim 10, wherein a fourth dimension is represented by a color of the graphical figure.

13. The system of claim 10, wherein multiple programs of the content are represented on the three-dimensional axis.

14. The system of claim 1, wherein the visual representation comprises a program map including at least one feature category plotted against time.

15. The system of claim 14, wherein existence of the feature associated with the feature category is represented by a colored bar.

16. The system of claim 14, wherein the at least on feature category is plotted against a time portion.

17. The system of claim 1, wherein the visual representation comprises a polygon including a frame of a program of the content on a first side of the polygon and information related to the frame on a second side of the polygon.

18. The system of claim 17, wherein the polygon is rotatable, such that a user can select to view either the first or second side.

19. The system of claim 1, wherein the visual representation comprises a series of multi-dimensional bars of varying heights arranged according to time.

20. The system of claim 1, wherein a level of the extracted features is represented by visualizing the size of a graphical image.

21. The system of claim 1, wherein a level of the extracted features is represented by the color of a graphical image.

22. The system of claim 1, wherein a level of the extracted features is represented by the texture of a graphical image.

23. The system of claim 1, wherein a level of the extracted features is represented by the shape of a graphical image.

24. The system of claim 1, further comprising an input device, wherein a user of the system can search the visual representation.

25. The system of claim 1, wherein the visual representation is presented of being browsed.

26. The system of claim 1, wherein the visual representation is transmitted to a remote device for display thereon.

27. The system of claim 1, wherein a user can interact with the visual representation using an input device.

28. A method of rendering a visual summary of a program, the method comprising:
receiving video content corresponding to a program from an external source;
analyzing the video content to identify and extract features from the video content;
calculating a level for each of the features extracted from the video content based on the prevalence of the features in the video content;
rendering a visual summary according to the calculated level for each of the extracted features; and
displaying the visual summary.

29. The method of claim 28, wherein the level for each of the features is calculated by continuously monitoring an intensity of a presence of the feature in the video content.

30. The method of claim 28, wherein the analyzing of the video source further comprises identifying a person in the video content.

31. The method of claim 30, wherein the person is identified by extracting faces, speech, and text from the video content, making a first match of known faces to the extracted faces, making a second match of known voices to the extracted voices, scanning the extracted text to make a third match to known names, and calculating a probability of a particular person being present in the video source based on the first, second, and third matches.

32. The method of claim 28 wherein the analyzing of the video source to extract stories comprises segmenting the video source into visual, audio and textual components, fusing the information, and segmenting and annotating the story internally.

33. The method of claim 28, wherein the features extracted from the video content are high-level inferences.

34. The method of claim 28, wherein the features extracted from the video content are low-level features.

35. The method of claim 28, further comprising analyzing information stored in a user profile and rendering a visual summary based on the information in the user profile.

36. The method of claim 28, further comprising accessing a second information source and augmenting the visual summary of the program with information gathered from the second information source, the gathered information being related to the features extracted from the video content.
